(19) United States
(12) Patent Application Publication
(10) Pub. No.: US 2026/0071978 A1
(43) Pub. Date: Mar. 12, 2026

(54) SAMPLE SUPPORT X-RAY DETECTOR

(71) Applicant: NanoElectronic Imaging, Inc., Riverside, CA (US)

(72) Inventor: William A Hubbard, Riverside, CA (US)

(21) Appl. No.: 19/223,005

(22) Filed: May 29, 2025

Related U.S. Application Data
(60) Provisional application No. 63/653,404, filed on May 30, 2024.

(51) Int. Cl. G01N 23/20025; G01N 23/20091

(52) U.S. Cl. CPC G01N 23/20025; G01N 23/20091; G01N 2223/309

(57) ABSTRACT

A sample support is provided including a base, an insulator, and one or more electrodes. The base has an upper surface with a first aperture and a lower surface with a second aperture. The insulator extends along the upper surface and/or the lower surface of the base. The insulator has a membrane that is a portion of the insulator that extends into the first aperture or the second aperture. One or more electrodes are electrically connected to the base and penetrate the insulator and/or the upper surface of the base. The sample object is placed on the membrane, the sample object emits x-rays, and the base absorbs a portion of the emitted x-rays and generates an electrical current. The electrode measures the electrical current and the electrical current allows for measurement and mapping physical properties of the sample object.

### TECHNICAL FIELD

This disclosure relates generally to a method of using an electron microscope and, more particularly, to a sample support that allows x-ray detection from a sample object for a transmission electron microscope.

### BACKGROUND INFORMATION

Energy Dispersive X-Ray Spectroscopy (“EDS”) measures the amount of specific elements on a sample object. This technique may be performed in a Transmission Electron Microscope (“TEM”), in a Scanning Electron Microscope (“SEM”), or with an x-ray beam. SEM and TEM EDS both involve shining an electron beam, generated by the electron microscope, onto the sample object and analyzing the x-rays emitted by the interaction of the electron beam and the sample object. EDS utilizes an energy-sensitive detector system to detect the location and energy of characteristic x-ray emissions from the sample object. These measurements can be used to quantify and map the abundance of atomic elements in the sample object.

Traditionally, EDS detectors 10 are separate devices that must be inserted into the TEM column 12 apart from the sample object 20, which is supported by a sample holder 16, as depicted in FIG. 1. The open space within the TEM column 12 is relatively small, and the structure of the EDS detector 10 and the sample holder 16 limits the detector solid angle, or how much of the space surrounding the sample object 20 has direct line-of-sight to the EDS detector 10, to typically less than 20% of the maximum, with some specialized configurations capable of up to 35% of the maximum. As a result, EDS measurements are limited in both accuracy and precision, for a given acquisition time, resulting in longer acquisition times and unreliable data. In the embodiment depicted in FIG. 1, only a portion of the x-rays emitted by the sample object 20 are detected. These received x-rays 22 are depicted with solid arrows, whereas a substantial portion of the x-rays 22 emitted by the sample object 20 are not detected by the EDS detector 10 and are depicted with dashed-line arrows.

Referring to FIG. 2, EDS generates an energy spectrum 18 of the x-rays 22 emitted by the sample object 20 by the electron beam 14. A given type of atom emits x-rays 22 of particular predictable energies, or “characteristic x-rays,” when exposed to a particle beam 14, which serve as a fingerprint for each element. An elemental map is generated by acquiring a spectrum 18 at every pixel of an image scan and fitting the characteristic x-rays to the peaks 19. EDS accessories known in the art for use with a TEM column 12 are limited in their detector solid angle, which determines how many of the total x-rays 22 emitted reach the EDS detector 10, and therefore how quickly statistically satisfactory measurements can be acquired.

Various types and configurations of EDS are known in the art. While these known EDS systems have various advantages, there is still room in the art for improvement, particularly for larger collector solid angles.

### SUMMARY

According to an aspect of the present disclosure, a sample support for imaging a sample object in a transmission electron microscope is provided. The sample support includes a base, an insulator, and one or more electrodes. The base has an upper surface with a first aperture and a lower surface with a second aperture. The insulator extends along the upper surface and/or the lower surface of the base. The insulator has a membrane that is a portion of the insulator that extends into the first aperture or the second aperture. One or more electrodes are electrically connected to the base and penetrate the insulator and/or the upper surface of the base. The sample object is placed on the membrane, the sample object emits x-rays, and the base absorbs a portion of the emitted x-rays and generates an electrical current. The electrode measures the electrical current and the electrical current allows for measurement and mapping physical properties of the sample object.

According to another aspect of the present disclosure, a sample support for imaging a sample object is provided that includes a base having a base material with an upper surface having a first aperture and an opposite lower surface having a second aperture, an upper insulator extending along the upper surface of the base, and an upper electrode penetrating the upper insulator. The upper insulator has a membrane that is the portion of the upper insulator spanning the first aperture. The sample object is disposed on the membrane, the sample object emits x-rays, the base absorbs a portion of the emitted x-rays and generates an electrical current, and the upper electrode measures the electrical current.

According to another aspect of the present disclosure, a sample support for imaging a sample object is provided that includes a first base having a lower surface with a first aperture, a first insulator extending along the upper surface and/or lower surface of the first base, a first electrode and a second electrode electrically connected to the first base and penetrating the first insulator and the upper surface and/or lower surface of the first base, a second base having an upper surface with a second aperture, a second insulator extending along the upper surface and/or lower surface of the second base, a membrane that is the portion of the second insulator spanning the second aperture, a third electrode and a fourth electrode electrically connected to the second base and penetrating the second insulator and the upper surface and/or lower surface of the second base, a first conductor and a second conductor. The sample object is placed on the membrane and the first base and the second base absorb x-rays emitted by the sample object and generate an electrical current measured by a combination of the first electrode, the second electrode, the third electrode, and the fourth electrode.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a side sectional view of a transmission electron microscope compatible with the sample support disclosed herein.

FIG. 2 is an example chart of x-ray emissions recorded by an EDS system in response to an electron beam.

FIG. 3A is a top view of a schematic of a sample support, according to an embodiment of the present invention.

FIG. 3B is a side sectional view of the sample support of FIG. 3A taken along line B-B.

FIG. 3C is a side sectional view of the sample support of FIG. 3A taken along line C-C.

FIG. 4 is a side sectional view diagramming the detector function of the embodiment in FIG. 3A.

FIG. 5A is a side sectional view taken along line C-C of FIG. 3A of an embodiment of a sample support.

FIG. 5B is a side sectional view taken along line C-C of FIG. 3A of another embodiment of the sample support.

FIG. 6A is a side sectional view taken along line B-B of FIG. 3A of an embodiment of a sample support.

FIG. 6B is a side sectional view taken along line B-B of FIG. 3A of another embodiment of a sample support.

FIG. 7A is a side sectional view taken along line B-B of FIG. 3A of another embodiment of a sample support.

FIG. 7B is a side sectional view taken along line B-B of FIG. 3A of another embodiment of a sample support.

FIG. 7C is a side sectional view taken along line B-B of FIG. 3A of another embodiment of a sample support.

FIG. 8A is a top view of a schematic of a sample support showing another embodiment of the present invention.

FIG. 8B is a side sectional view of one embodiment of the sample support of FIG. 8A taken along line B-B.

FIG. 9A is a top view of a schematic of a sample support showing another embodiment of the present invention.

FIG. 9B is a partial view of the sample support of FIG. 9A within the square B showing an embodiment of the present invention.

FIG. 9C is a partial view of the sample support of FIG. 9A within the square B showing another embodiment of the present invention.

FIG. 9D is a partial view of the sample support of FIG. 9A within the square B showing another embodiment of the present invention.

FIG. 10A is a top view of a schematic of a sample support showing another embodiment of the present invention.

FIG. 10B is a side sectional view of the sample support of FIG. 10A taken along line B-B.

FIG. 10C is a side sectional view of the sample support of FIG. 10A taken along line C-C.

FIG. 10D is a side sectional view of the sample support of FIG. 10A taken along line C-C showing another embodiment of the present invention.

FIG. 11A is a top view of a schematic of a sample support showing another embodiment of the present invention.

FIG. 11B is a bottom view of the sample support of FIG. 11A.

FIG. 11C is a side sectional view of the sample support of FIG. 11A taken along line C-C.

FIG. 11D is a partial view of the sample support side section of FIG. 11C within square D diagramming the detector function of the embodiment in FIG. 11C.

FIG. 12A is a top view of a schematic of a sample support showing another embodiment of the present invention.

FIG. 12B is a side sectional view of the sample support of FIG. 12A taken along line B-B.

FIG. 13 is a side sectional view of a sample support showing another embodiment of the present invention.

FIG. 14 is a side sectional view of a sample support showing another embodiment of the present invention.

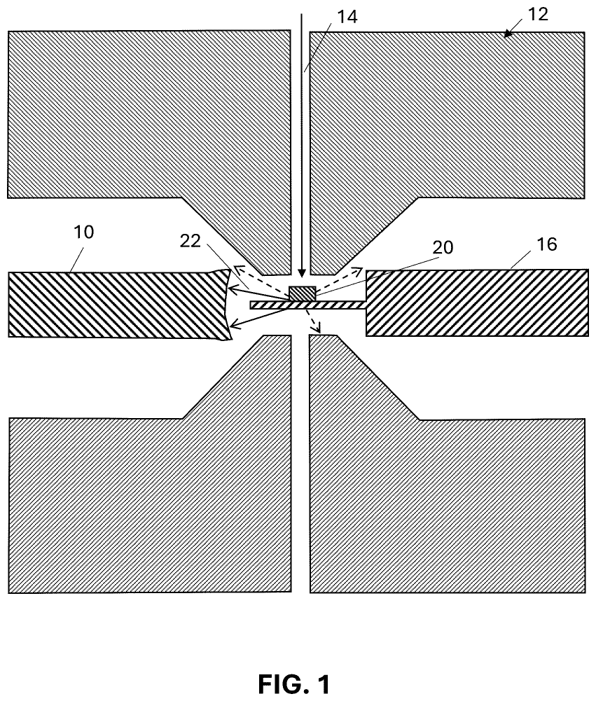

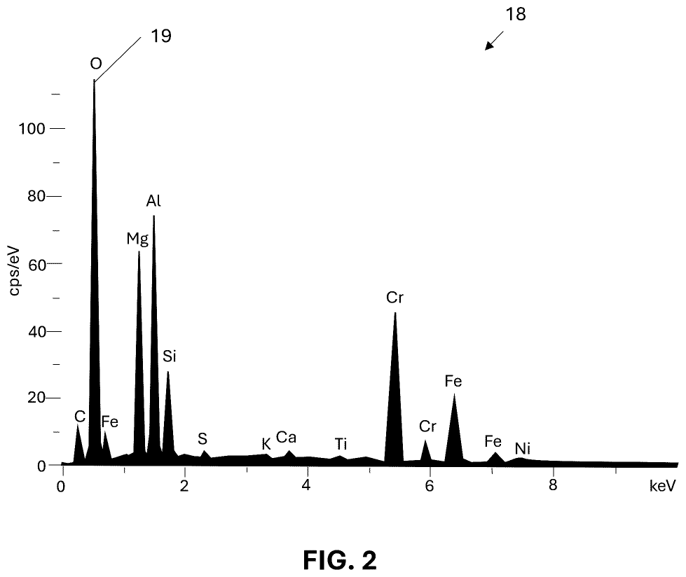

### DETAILED DESCRIPTION

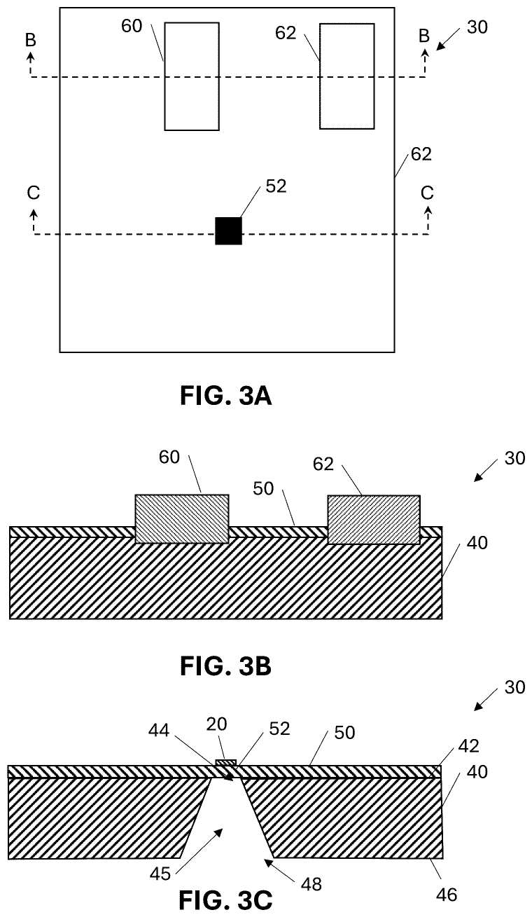

FIGS. 3A, 3B, and 3C illustrate schematics of the basic elements of a sample support 30, according to an embodiment of the present invention. A sample object 20 (e.g., a specimen or a sample such as an electronic device, a virus, a nanoparticle, etc.) is placed on the sample support 30 for imaging with an x-ray stimulating beam, such as the electron beam 14 of a TEM column 12, according to the method disclosed herein. The sample support 30 includes a base 40, an insulator 50, and at least one electrode (FIGS. 3A-3B depict two electrodes 60, 62). The various embodiments of the sample support 30 disclosed herein allow direct detection of x-rays 22 emitted by the sample object 20. In other words, electrical currents generated within the sample support 30 are detectable and measurable in response to x-rays 22 emitted by the sample object 20.

In the embodiment depicted in FIG. 3A, the base 40 is a semiconductor material that supports an insulator 50 in the form of a thin film. The base 40 extends from an upper surface 42 that defines a first aperture 44 to a lower surface 46 that defines a second aperture 48. There is a void 45 of material between the first aperture 44 and the second aperture 48 within the base 40. The insulator 50 extends along the upper surface 42 of the base 40. The insulator 50 has a membrane 52, which is defined as the portion of the insulator 50 that extends into the first aperture 44. An alternate embodiment in which the insulator 50 extends along the lower surface 46 of the base 40 and the membrane 52 is defined as the portion of the insulator 50 that extends into the second aperture 48 does not depart from the invention disclosed herein. In the depicted embodiments, the first aperture 44 and second aperture 48 are each defined by a square. Apertures defined by other shapes including circles, rectangles, ovals, etc. do not depart from the invention disclosed herein. Additionally, the first aperture 44 and the second aperture 48 discussed herein are centered about a single line. Angling the apertures relative to one another and/or incorporating apertures of different shapes and/or sizes does not depart from the invention disclosed herein.

The membrane 52 is electrically isolated from the base 40, and the sample object 20 is disposed or placed on top of the membrane 52, providing support to the sample object 20 without impeding passage of the electron beam 14. In some embodiments, such as that depicted in FIG. 3C, the membrane 52 is formed by removing base material below a small region of an insulating film 50 coating the surface of the base 40. In the embodiment depicted in FIG. 3A, the membrane 52 is a window defined by a square or rectangle within and surrounded by the base 40.

At least one electrode 60, 62 is electrically connected to the base 40. The electrodes 60, 62 penetrate the insulator 50 and the upper surface 42 of the base 40. Electrodes that do not penetrate the insulator 50 and/or the upper surface 42 of the base 40 do not depart from the invention disclosed herein. At least one electrode 60 forms a non-ohmic connection with the base 40. In other words, at least one electrode has a connection with the base that exhibits a non-linear current-voltage response. In some embodiments, at least one of the electrodes forms an ohmic connection with the base 40 and at least one of the electrodes forms a rectifying connection with the base 40. The electrodes 60, 62 are connected to current measurement electronics that are connected to a computer (not depicted) for recording and analyzing. The current generated between the electrodes 60, 62, allows for the measurement and mapping of physical properties of the sample object 20. These physical properties include, but are not limited to, the composition and thickness of specific points on the sample object 20. While only two rectangular electrodes are depicted in FIG. 3A, changing the number of electrodes, the geometry of the electrodes, or the pattern of the electrodes do not depart from the invention disclosed herein. For example, in some embodiments multiple similar electrodes are patterned in concentric circles and current is measured from each of them separately, in parallel, or some combination thereof.

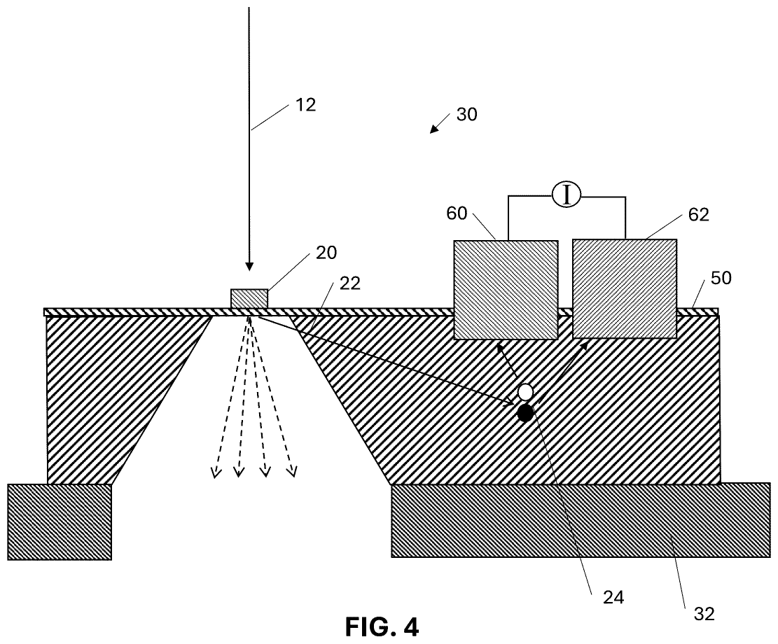

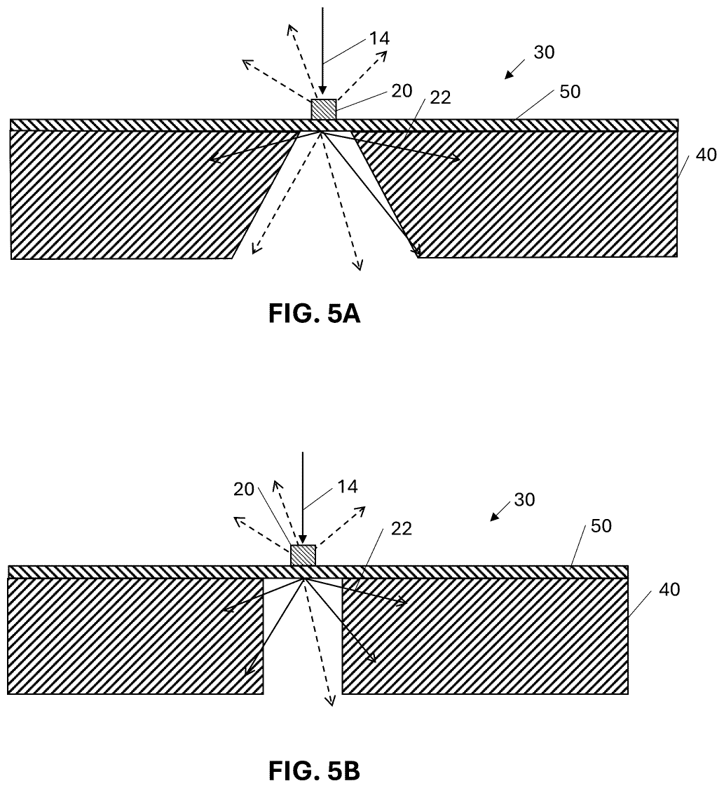

The sample object 20 is disposed on the membrane 52. X-rays 22 are emitted from the sample object 20 when it is irradiated with a stimulating beam 14. A portion of the x-rays 22 emitted by the sample object 20 are absorbed by the base 40. These absorbed x-rays 22 are depicted with solid arrows. A portion of the x-rays 22 emitted by the sample object 20 are not absorbed by the base 40, as depicted in FIGS. 4-5B with dashed line arrows. In the embodiment depicted in FIG. 4, x-rays 22 that are absorbed by the base 40 produce electron-hole pairs 24 in the base material. The non-ohmic connection or contact at the electrodes 60, 62 promotes separation of those pairs, creating a current that can be measured between the electrodes 60, 62, as depicted in FIG. 4. In some embodiments, a voltage is applied between the electrodes to further promote electron-hole pair separation. The resulting current is measured in aggregate over longer time periods for single-pixel x-ray detection. Individual x-ray interaction events are detected at higher speeds, with the assistance of detector cooling and optimized electrode geometries, to form an energy-resolved detector for x-ray spectroscopy. In some embodiments, cooling is achieved by circulating coolant through the sample holder 16 near the sample support 30 or by placing the sample support 30 on a thermoelectric cooler 32 mounted on the sample holder 16, as depicted in FIG. 4. In the depicted embodiment, the thermoelectric cooler 32 also defines an aperture that is sufficiently large so as not to impede the electron beam.

In some embodiments, the base 40 is made out of Silicon. Silicon provides benefits in that it is easy to obtain and process, and its interaction with x-rays are predictable. Silicon is also a common material used for x-ray detectors and spectrometers that extract measurements from x-ray-induced detector currents. In some embodiments, the base 40 is intrinsic, doped, or Li-drifted Silicon. Alternatively, in some embodiments the base is made of a semiconducting material, including but not limited to, gallium nitride, diamond, germanium, gallium arsenide, and silicon carbide.

In some embodiments, the insulator 50 coating the surface of the base 40 and defining the membrane 52, as depicted in FIG. 3C, is composed of a film of silicon dioxide, silicon nitride, or layers of each as may be necessary to facilitate fabrication. For example, a thick sacrificial silicon dioxide layer supports a thinner silicon nitride membrane to reinforce the membrane during processing, and the silicon dioxide is then etched in the final processing step leaving only the thin silicon nitride. In some embodiments, both surfaces of the silicon base 40 are polished and insulating films 50 coat both surfaces. In some embodiments, the membrane 52 is a thin window (e.g., having a thickness of approximately 200 nanometers or less) that is formed in the sample support 30. In some embodiments, the base 40 is composed of silicon oriented in the <100>crystal direction and the membrane 52 is formed by anisotropic etching in potassium hydroxide, which selectively removes silicon to reveal the membrane 52. The walls of the silicon below the membrane 52 are sloped outwards as a result of the potassium hydroxide etching, as depicted in FIG. 5A. In some embodiments, the silicon below the membrane 52 is removed by deep reactive ion etching, which instead allows for straight walls, as depicted in FIG. 5B. The straight walls result in a slightly higher detector solid angle for a given window size of the membrane 52 and base 40 thickness.

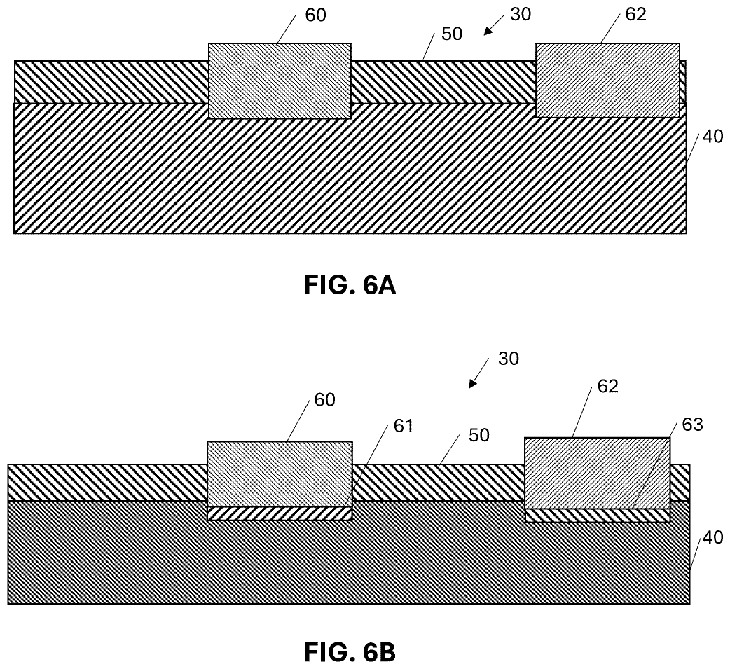

FIGS. 6A and 6B depict two embodiments in which both electrodes 60, 62 penetrate the top surface of the insulator 50 to form a contact with the base 40. As depicted in FIG. 6A, both electrodes 60, 62 are directly connected to the base 40, with one contact forming an ohmic connection and the other a Schottky connection. One embodiment includes a p-doped silicon base 50, one gold contact that makes ohmic connection, and one aluminum contact that makes a rectifying connection. In one embodiment, at least one contact is made by first introducing dopant atoms to the base 40 and then depositing the metal electrode. FIG. 6B depicts, the base has a first region 61 adjacent to one electrode 60 that has an electric field polarity and a second region 63 adjacent to another electrode 62 with an opposite electric field polarity to the first region 61. The first region 61 is formed by introducing a p-type dopant such as Boron to the base 40. The second region 63 is formed by introducing an n-type dopant such as Phosphorous to the base 40. In some embodiments, the first region 61 and at least one electrode surround the membrane 52 on the upper surface 42 of the base 40 and the second region 63 and at least one additional electrode surround the second aperture 48 on the lower surface 46 of the base. In one embodiment, a lightly n-doped silicon base 40 has Boron (p-type) doping 61 below one contact, high Phosphorus (n-type) doping 63 below the other, and aluminum metal forming both electrodes 60, 62. In some embodiments, dopants are introduced at the surface of the base 40 by various methods, including but not limited to ion implantation and thermal diffusion. In some embodiments, the Boron (p-type) doping 61 has a concentration of Boron between 1×10¹⁵/cm³ and 1×10¹⁸/cm³ and the Phosphorous (n-type) doping 63 has a concentration of Phosphorous between 1×10¹⁵/cm³ and 1×10¹⁸/cm³. In some embodiments, the base 40 is made out of Silicon that is n-doped with a concentration of Phosphorous of approximately between 1×10¹²/cm³ and 1×10¹³/cm³. In some embodiments, the base 40 is made out of Silicon that is p-doped with a concentration of Boron of approximately 1×10¹⁵/cm³.

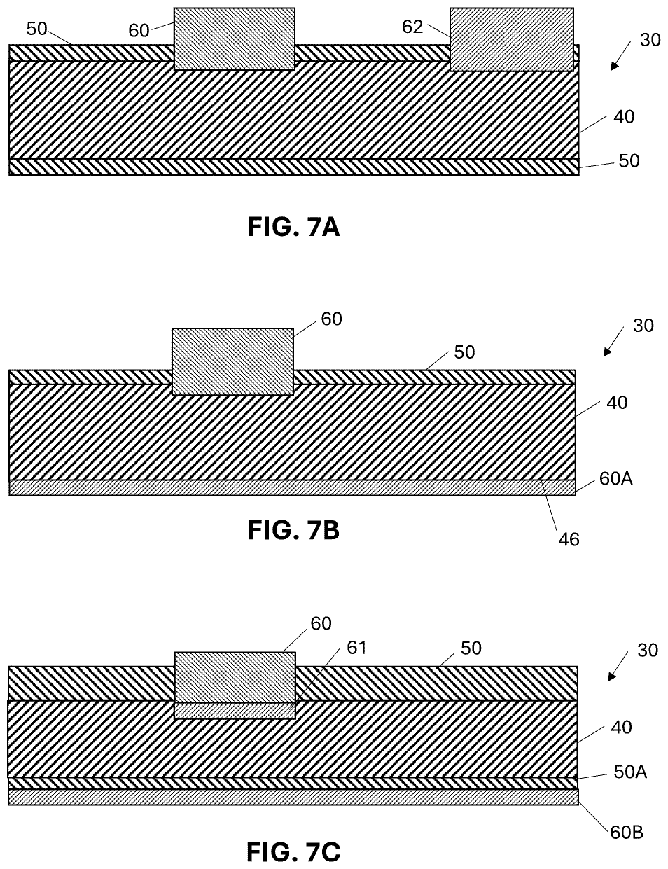

FIGS. 7A, 7B, and 7C depict embodiments with various materials coating the lower surface of the base 40. In FIG. 7A, an insulator 50 coats the lower surface and both electrical connections with the electrodes 60, 62 are made to the top surface of the base 40. In FIGS. 7B and 7C, one electrode 60A electrically connects to the lower surface 46 of the base 40. The electrical connection is made either by direct metal contact 50B with the base 40 or by first doping the base 40. In FIG. 7C, a doped layer 50A is first produced at the lower surface 46 of the base 40 before deposition of a metal bottom electrode 60B.

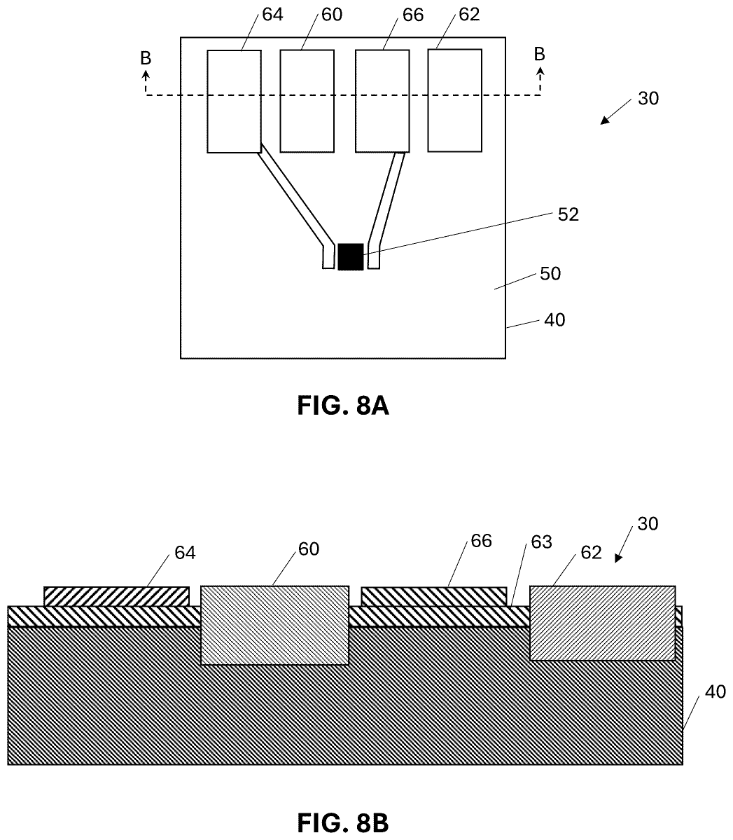

FIGS. 8A and 8B depict an embodiment in which isolated electrodes 64, 66 are patterned on top of an insulator 50 that electrically isolates them from the base 40 and each other. In some embodiments, electrodes 64, 66 are isolated from detector electrodes 60, 62. In other embodiments, 64, 66 are connected directly to detector electrodes 60, 62 to carry detector current signals. In the depicted embodiment, the isolated electrodes 64, 66 extend to the sample object 20 in order to stimulate the sample object 20 electrically or thermally (i.e. heating), to obtain electrical measurements, and/or to reduce charging of the sample object 20. Capturing, or routing to ground, the current at the detector electrodes 60, 62 also reduces or prevents mixing of x-ray-generated electronic signals from other electronic signals of interest measured by the isolated electrodes 64, 66 (e.g., electron beam-induced currents, electrical testing). In some embodiments, these electrodes 64, 66 are comprised of a film of a single conductor material, or multiple material layers to, for example, facilitate adherence of a conducting layer to the underlying insulator 50. In one embodiment, a silicon nitride insulator layer 50 is patterned and coated with a 5 nm-thick adhesion layer of titanium followed by a 100 nm-thick layer of platinum. While only two electrodes 64, 66 are depicted in FIG. 8A, changing the number of electrodes, the geometry of the electrodes, or the pattern of the electrodes, including connecting the electrodes to a heating element or other patterned electronic device, do not depart from the invention disclosed herein.

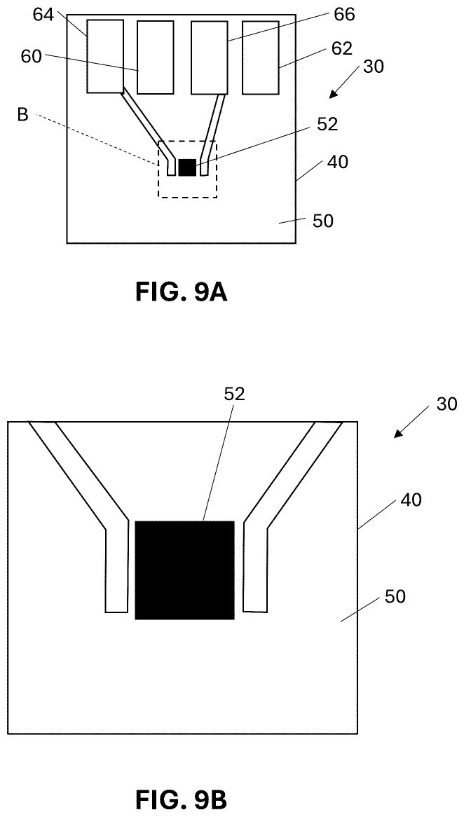

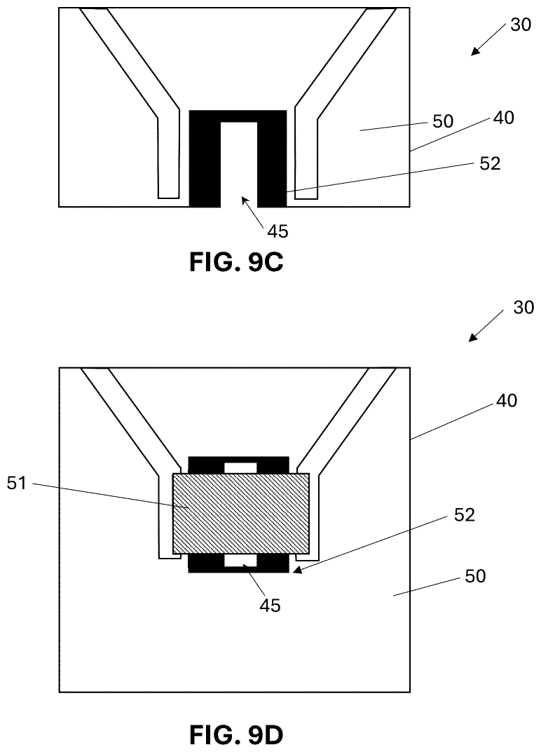

FIGS. 9A, 9B, 9C, and 9D depict embodiments with different configurations of the membrane 52, each having isolated electrodes 64, 66, on either side of the membrane 52. In FIGS. 9A and 9B, the membrane 52 is fully contained within the chip and consists of a solid insulating material 50. In FIG. 9C, the membrane 52 is formed at the edge of the chip and is partially cut away forming a void 45 to allow samples to be fully suspended. In FIG. 9D, a conducting film 51 is suspended over a void 45 produced in the membrane 52 and is connected on either side to adjacent isolated electrodes 64, 66. A sample object 20 can then be placed on the conducting film 51. In some embodiments, this conducting film 51 includes, but is not limited to, a film or mesh of amorphous carbon, a thin film metal, and a layered material such as graphene. Such a film has advantages over a purely insulating film because it helps eliminate charging of the sample object 20, it is capable of being a much thinner support (such as in the case of graphene), it provides lower background signal for other measurements (such as electron energy loss spectroscopy), and it is used to heat the entire sample support region by driving a current through the film.

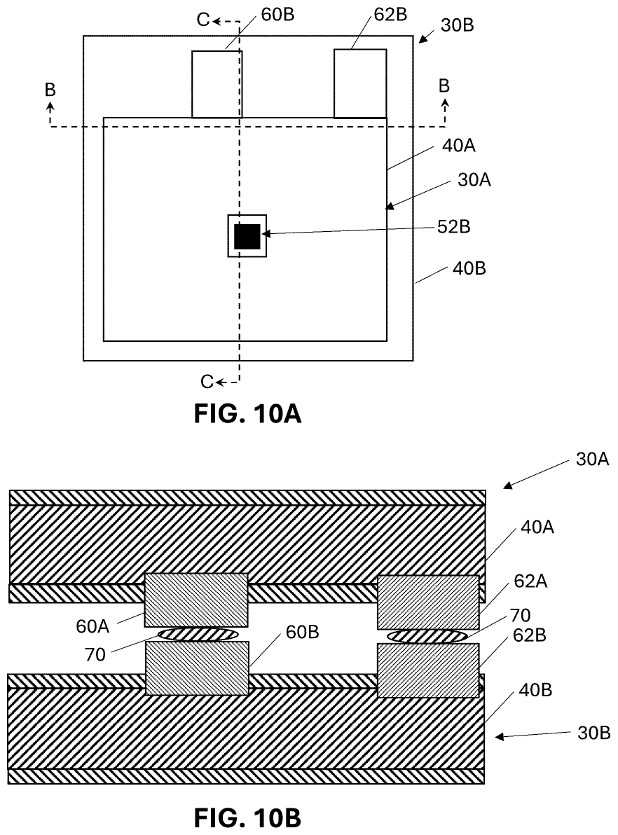

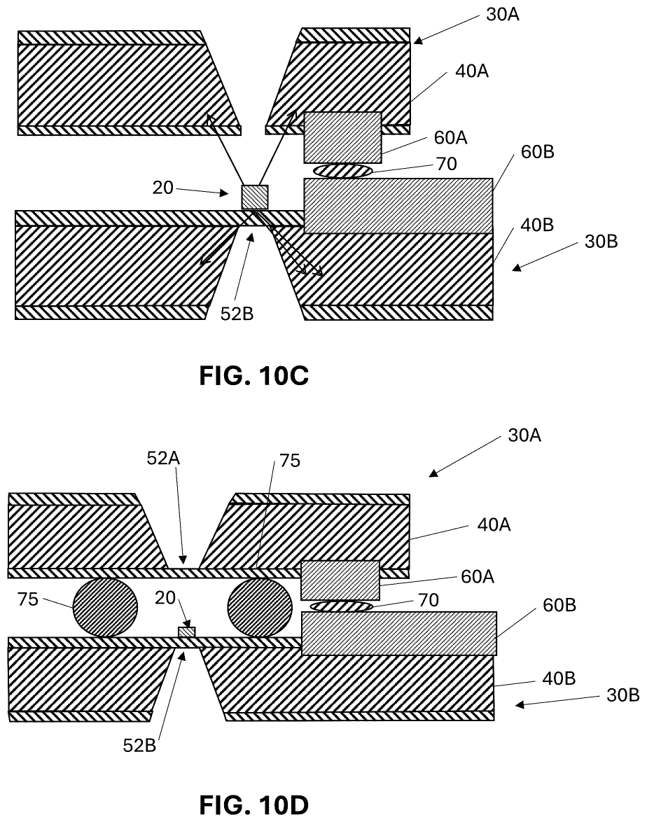

FIGS. 10A, 10B, and 10C depict an embodiment in which two bases 40A, 40B are sandwiched against one another, which has the effect of doubling the detector solid angle relative to the single-support configurations shown in FIGS. 3A-9D. This is achieved by placing a sample object 20 on a sample support 30B, in the normal orientation, and then placing a second sample support 30A upside-down, and in contact with corresponding electrodes 60B, 62B on the bottom support 30B. The electrodes 60A and 60B, and 62A and 62B, on both supports 30A, 30B can be electrically connected by, for example, depositing a low-melting-point conductor 70 (e.g., solder, indium, etc.) on the electrodes 60A, 62A, 60B, 62B and heating. These connections also help to mechanically hold the supports 30A, 30B in place, but other reinforcement techniques, such as epoxy or clamping, do not depart from the invention disclosed herein. Alternatively, in some embodiments the structure is monolithic in which the bottom base and the top base are two halves of a single, gap-less structural unit. In some embodiments, the gap-less structural unit is fabricated by wafer-bonding the two sample supports together. While the bottom support 30B requires a membrane 52, in some embodiments a membrane is not required in the top support 30A, as depicted in FIG. 10C, in cases where it may unnecessarily impede the incident beam 14. In some embodiments, both sample supports 30A, 30B contain solid membranes 52A, 52B and have a sealant 75 (e.g., an epoxy, an O-ring, a spacer, etc.) between them to form a chamber of gas, liquid, or vacuum through which the beam 14 can pass, as depicted in FIG. 10D. In some embodiments, the top support 30A does not include contacts 60A, 62A to the base 40A and serves only to form an enclosed chamber on top of the bottom support 30B. In some embodiments, the top support 30A is smaller than the bottom support 30B to allow room for aligning the openings in the bases 40A, 40B and to access the electrodes 60B, 62B on the bottom support 30B (to which connection will be made to measurement electronics).

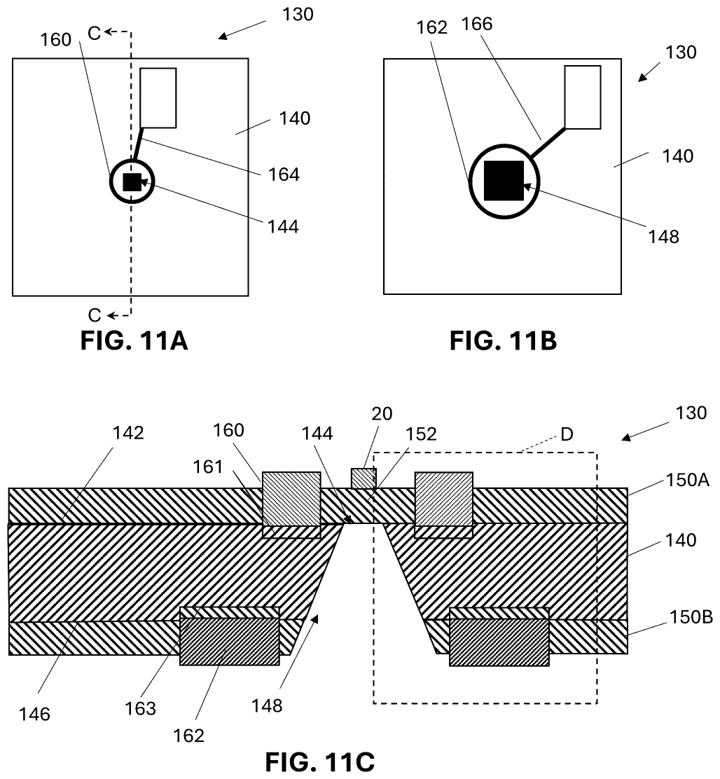

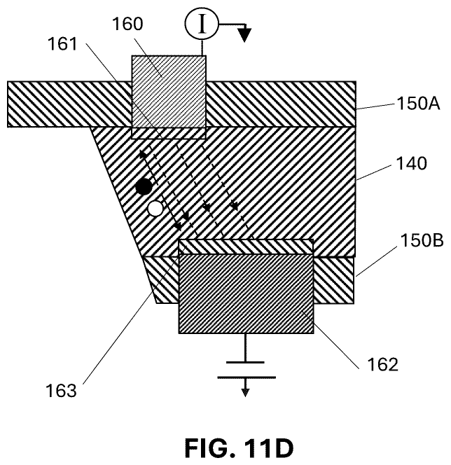

FIGS. 11A-11D depict an embodiment of the sample support 130 in which the base 140 defines a first aperture 144 at an upper surface 142 and a second aperture 148 at a lower surface 146 and the base 140 is sandwiched between an upper insulator 150A and a lower insulator 150B. The upper insulator 150A defines a membrane 152 above the first aperture 144 and the lower insulator 150B defines a hole below the second aperture 148. A first electrode 160 penetrates the upper insulator 150A and surrounds the first aperture 144. A second electrode 162 penetrates the lower insulator 150B and surrounds the second aperture 148. In some embodiments, the first electrode 160 only partially surrounds the first aperture 144. In some embodiments, the second electrode 162 only partially surrounds the second aperture 148. In some embodiments, the second electrode is omitted, the lower insulator is removed, and the base is placed on a conducting surface. In some embodiments, the first and second electrodes surround the first and second apertures at a distance of roughly 100 micrometers, and the first and second electrodes define a ring having a thickness measured in the radial direction of roughly 0.5 micrometers or less.

FIG. 11D depicts a diagram of the sample support of FIG. 11C. The first electrode 160 is connected to a circuit that measures current. In some embodiments, the first electrode 160 is held at ground and the second electrode 162 is supplied with a negative bias. In some embodiments, the first electrode 160 is supplied with a positive bias and the second electrode 162 is connected to a ground. In both cases, the first electrode 160 measures electrons, and the second electrode 162 measures holes that are separated by the electric field produced by the voltage difference. The arrangement of the electrodes 160, 162 around the first and second apertures 144, 148 creates an electric field gradient that pushes the electrons generated far from the center of the membrane 152 towards the first electrode 160 so that they can be collected (as depicted in FIG. 11D). In some embodiments, there are one or more additional rings surrounding, or inside, the first and second electrodes 160, 162 that serve to measure signal, provide a potential gradient, or to ground or otherwise guard against electrical interference.

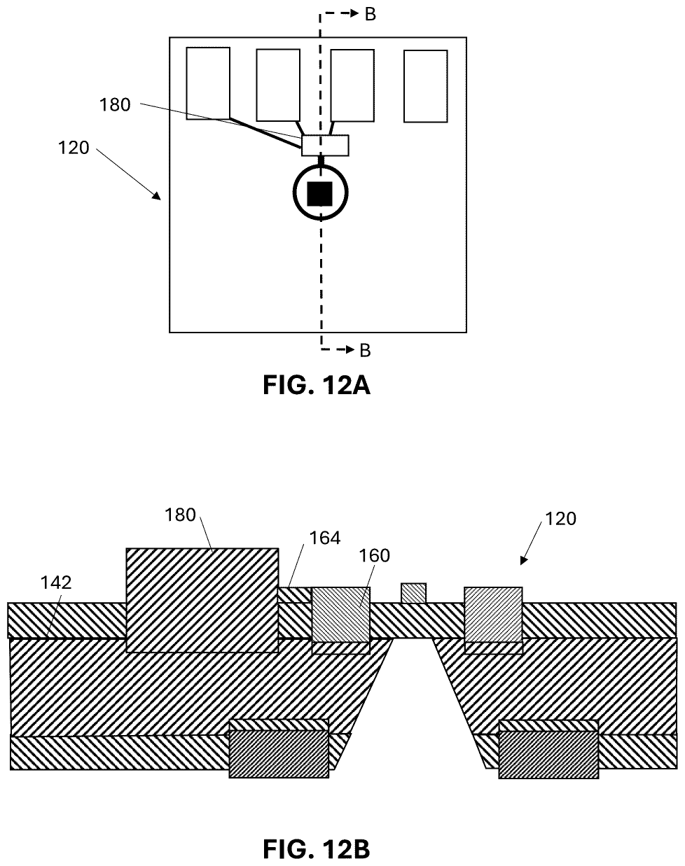

FIGS. 12A and 12B depict an embodiment of a sample support 130 in which a field-effect transistor 180 is integrated into the sample support 130. In the depicted embodiment, the transistor 180 is fabricated directly on the upper surface 142 of the base 140. The first electrode 160 is connected to the transistor gate while a voltage is supplied between source and drain, and the transistor 180 amplifies the signal from the first electrode 160 while minimizing device capacitance. In some embodiments, the transistor 180 consists of source and drain electrodes patterned on selectively doped regions of the upper surface 142 of the base 140 where the upper insulator 150A has been removed, with an additional insulating layer and gate electrode to modulate the conductance of the channel between source and drain. In some embodiments, charging on the gate is periodically reset with a voltage pulse. In some embodiments, structures such as diodes or more complicated transistor structures are fabricated adjacent to the transistor structure to enable faster resets. In some embodiments, transistor structures are designed for continuous readout without the need for resetting.

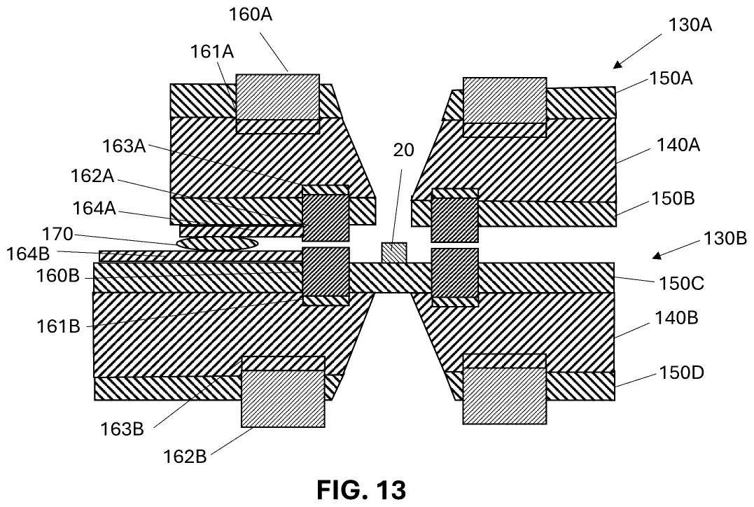

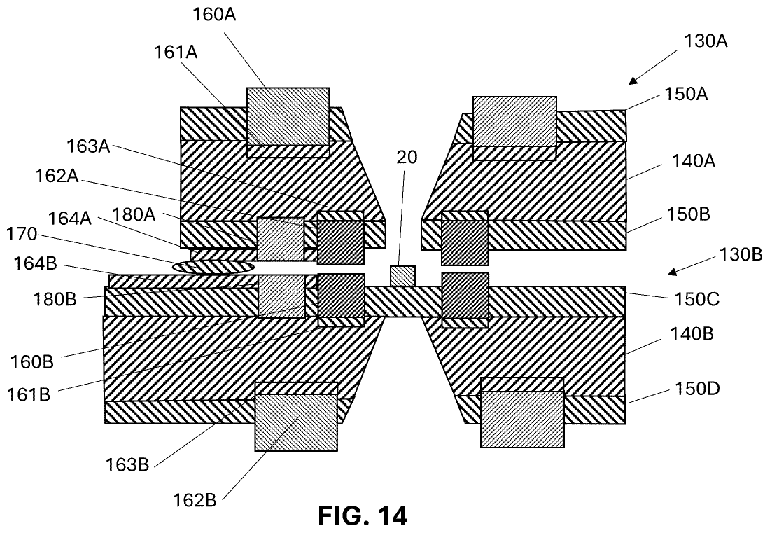

FIG. 13 depicts an embodiment in which two sample supports 130A, 130B as depicted in FIG. 11C are sandwiched against one another. The sample supports 130A, 130B are held apart by a conductor 170 retained between metal leads 164A of the upper sample support 130A and metal leads 164B of the lower sample support 130A. In the embodiment depicted in FIG. 14, a transistor 180A, 180B is integrated into the electrical connection to the second electrode 162A of the upper sample support 130A and the electrical connection to the first electrode 160B of the lower sample support 130B.

The sample support disclosed herein includes embodiments that can be used with any number of complicated samples deposited or fabricated on such a sample support. This includes but is not limited to fluid chambers, cryogenically cooled samples, planar and vertically aligned electronic devices, biological samples, quantum dots, nanomaterials, etc.

In some embodiments, the sample support is a consumable or fungible item. In some embodiments, the sample support is replaced after a small number of uses, i.e., exposures to electrons by the TEM. The structure of the sample support allows for a detector solid angle (area with unhindered line of sight to the detector) of up to approximately 3.75 steradians for a single-chip design (FIGS. 3-9) and up to approximately 7.5 steradians for a double-chip configuration (FIGS. 10-14). The single-chip sample support design allows for a significant increase in solid angle over most TEM x-ray detectors in the art, which detect with 2.2 steradians or less. The double-chip sample support design allows for a significant increase in solid angle over the leading x-ray detector in the art for TEM, which can achieve 4.5 steradians when used in a specialized microscope with an optimized sample holder. The sample support disclosed herein is compatible with any TEM, provided it can be mounted in an appropriate sample holder, and can achieve large collection angles regardless of the geometry of, or other accessories within, the TEM column. The structure of the sample support detector also does not require any installation of x-ray detection hardware onto the TEM column 12, as the detector is inserted and retracted with the sample holder during each use of the TEM.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. A sample support for imaging a sample object, the sample support comprising:
a base having an upper surface defining a first aperture and a lower surface defining a second aperture;
an insulator extending along at least one of the upper surface and the lower surface of the base, the insulator having a membrane defined by a portion of the insulator extending into at least one of the first aperture and the second aperture; and
at least one electrode electrically connected to the base and penetrating at least one of the insulator and the upper surface of the base,
wherein the sample object is disposed on the membrane, the sample object emits x-rays, the base absorbs a portion of the emitted x-rays and generates an electrical current, and the at least one electrode measures the electrical current, and
wherein the electrical current received by the at least one electrode allows for measurement and mapping physical properties of the sample object.

2. The sample support of claim 1, further comprising at least one additional electrode electrically connected to the base and penetrating at least one of the insulator, the upper surface, and the lower surface of the base.

3. The sample support of claim 1, wherein the first aperture and the second aperture each have perimeters that are defined by a square.

4. The sample support of claim 1, wherein the electrical current received by the at least one electrode is routed to a ground.

5. The sample support of claim 1, wherein the physical properties of the sample object include composition and thickness.

6. The sample support of claim 1, wherein the at least one of the electrode forms a non-ohmic connection with the base.

7. The sample support of claim 2, wherein at least one of the electrodes forms an ohmic connection with the base and at least one of the electrodes forms a rectifying connection with the base.

8. The sample support of claim 7, wherein the base is made from a p-doped silicon, the at least one electrode forming an ohmic connection is made out of gold, and the at least one electrode forming a rectifying connection is made out of aluminum.

9. The sample support of claim 1, wherein the at least one electrode forms a rectifying connection with the base, and
wherein the base has a first region adjacent to the connection with the at least one electrode, the first region has an electric field polarity and the first region is formed by introducing a p-type dopant to the base.

10. The sample support of claim 9, further comprising at least one additional electrode forming a rectifying connection with the base,
wherein the base has a second region adjacent to the at least one additional electrode, the second region has an opposite electric field polarity to the first region and the second region is formed by introducing an n-type dopant to the base.

11. The sample support of claim 10, wherein the base is made out of n-doped silicon, the first region is formed by introducing an n-type dopant to the base, the second regions is formed by introducing a p-type dopant to the base, and the at least one electrode and the at least one additional electrode are made out of aluminum.

12. The sample support of claim 10, wherein the first region and the at least one electrode surround the membrane on the upper surface of the base, and
wherein the second region and the at least one additional electrode surround the second aperture on the lower surface of the base.

13. The sample support of claim 1, further comprising a cooling element defining a cooling aperture,
wherein the sample support rests on the cooling element and a portion of the emitted x-rays pass through the cooling aperture.

14. The sample support of claim 10, wherein at least one of the first region and the second region is electrically connected to the gate terminal of a transistor.

15. A sample support for imaging a sample object, the sample support comprising:
a base having a base material defining an upper surface having a first aperture and an opposite lower surface having a second aperture;
an upper insulator extending along the upper surface of the base, the upper insulator having a membrane defined as the portion of the upper insulator spanning the first aperture;
an upper electrode penetrating the upper insulator adjacent to the membrane,
wherein the sample object is disposed on the membrane, the sample object emits x-rays, the base absorbs a portion of the emitted x-rays and generates an electrical current, and upper electrode measures the electrical current.

16. The sample support of claim 15, further comprising:
a lower insulator extending along the lower surface of the base; and
a lower electrode penetrating the lower insulator,
wherein the lower electrode contributes to measuring the electrical current.

17. The sample support of claim 16, wherein at least one of the upper electrodes also penetrates the upper surface of the base and the lower electrode also penetrates the lower surface of the base.

18. The sample support of claim 16, wherein the base has a first region adjacent to the connection with the upper electrode, the first region has an electric field polarity and the first region is formed by introducing a p-type dopant to the base and a second region adjacent to the lower electrode, the second region has an opposite electric field polarity to the first region and the second region is formed by introducing an n-type dopant to the base.

19. The sample support of claim 16, wherein at least one of the upper electrode fully surrounds the membrane and the lower electrode fully surrounds the second aperture.

20. A sample support for imaging a sample object, the sample support comprising:
a first base having a lower surface defining a first aperture;
a first insulator extending along the lower surface of the first base;
a first electrode and a second electrode electrically connected to the first base and penetrating the first insulator and the lower surface of the first base;
a second base having an upper surface defining a second aperture;
a second insulator extending along the upper surface of the second base, the second insulator having a membrane defined by the portion of the second insulator spanning the second aperture;
a third electrode and a fourth electrode electrically connected to the second base and penetrating the second insulator and the upper surface of the second base;
a first conductor retained between one of the first electrode and the second electrode and one of the third electrode and the fourth electrode; and
a second conductor retained between another one of the first electrode and the second electrode and another one of the third electrode and the fourth electrode;
wherein the sample object is disposed on the membrane and the first base and the second base absorb x-rays emitted by the sample object and generate an electrical current measured by a combination of the first electrode, the second electrode, the third electrode, and the fourth electrode.
